(19) United States
(12) Patent Application Publication
(10) Pub. No.: US 2007/0170194 A1
(43) Pub. Date: Jul. 26, 2007

(54) Dispenser for solid medicament portions and its use

(76) Inventor: Sabine Leifeld, Berlin (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/542,637

(22) Filed: Oct. 4, 2006

(30) Foreign Application Priority Data
Oct. 5, 2005 (DE) 102005048515.4

(51) Int. Cl. G07F 11/00

(52) U.S. Cl. 221/3; 700/231

(57) ABSTRACT

The present invention relates to a dispenser for solid medicament portions, comprising: a case ((1 FIG. 2) for the medicament portions and means for providing a reminder to administer the medicament portions. The means for providing a reminder comprise at least one processor unit, at least one signalling device ((13 FIG. 2) which is associated with the at least one processor unit, and at least one means ((11 FIG. 1), which is associated with the at least one processor unit, for confirming that a medicament portion has been administered, and also at least one means ((10 FIG. 1), which is associated with the at least one processor unit, for initializing a break period in administration of the medicament portions after an administration phase.

The present invention relates to a dispenser for solid medicament portions and its use for hormonal medicaments for contraception or hormone replacement therapy.

Medicaments in solid form are usually prepared in the form of pills, coated pills, capsules, tablets and other solid presentation forms. If medicaments of this type are not supplied in a container from which they can be poured out, they may also be packaged in so-called blister packs (PTP: push-through pack). The latter type of packs generally comprise a mainly transparent plastic casing, which has accommodating cavities for the medicament portions, and an aluminium foil which can be welded to this casing. In order to be used, the medicament portions can be removed by being pushed through the aluminium foil from the direction of the accommodating cavity, in the process of which the aluminium foil breaks open. The receptacles formed by the individual accommodating cavities hermetically seal the portions from the time at which they are wrapped to the time at which they are used, so that the medicament portions are protected against mechanical and chemical damage.

For therapeutic purposes, the medicaments are to be taken in accordance with the directions of use in specific dosages and at specific time intervals. In most cases, this does not present any problems but, particularly when the medicaments are taken over a relatively long period of time, may in some cases lead to the medicaments not being taken or not being taken at the prescribed time. As a result, the success of the treatment is put at risk in many cases. Therefore, many attempts have been made to monitor the administration of medicaments, with particular emphasis being placed on self-monitoring by the patients themselves.

In order to eliminate the abovementioned problems, proposals have been made to provide the patient with aids which can be used to ensure that the medicament is administered in a controlled manner in spite of the patient being distracted by everyday life. To this end, apparatuses for accommodating medicament packs are described, for example, from which the removal of individual tablets is automatically registered. Various proposals have been made for this purpose:

DE 198 50 890 A1 describes an apparatus for storing medicaments which are to be administered regularly, which apparatus comprises a storage container for the medicaments which are divided into portions, a device for dispensing quantities of the medicament in portions, a timer for determining that the medicament is due to be administered, a signal transmitter for indicating that the medicament is due to be administered, and a sensor for detecting that a medicament portion has been removed. To this end, a carousel-like storage container is provided which is provided with a slide for releasing the portions which are stored on the carousel. Operating the slide, which remains locked before administration of the medicament is due, starts up a counter and again cancels an alarm which is set off when administration is due. An optical indicator outputs the time, the date and/or the day of the week in an alphanumeric fashion. In addition, an acoustic signal can also be output. The medicaments may be contraceptives, for example.

DE 197 39 438 A1 describes another variant in which a blister pack is equipped with sensors which emit signals when a medicament sample is removed, with an evaluation circuit and optionally with memories, which blister pack processes the signals from the sensors, and determines and stores therapeutically relevant data from said signals. The sensors, the evaluation circuit and the memories are integrated in the blister pack. When a tablet is pushed through the lower foil of the blister pack, a conductor track which is located there is destroyed, so that an electrical signal is generated. A clock function, decoding of the desired alarm time and generation of a specific signal pulse sequence for an acoustic signal transmitter are implemented in the evaluation circuit.

In a similar manner, DE 195 16 076 A1 describes a magazine for dimensionally stable medicament samples which comprises sensors, which emit signals when a medicament sample is removed, and an evaluation circuit with memories, which evaluation circuit processes the signals from the sensors, determines therapeutically relevant data from said signals and stores said data. In this case, a sensor foil which has conductor tracks takes over the function of sensors. The conductor tracks are severed when the tablets are pressed out of the blister pack. The patient is reminded when a medicament is due to be administered, for example by means of an acoustic signal.

A similar principle is described in DE 198 52 602 A1 and DE 102 13 547 C1. The medicaments mentioned in DE 198 52 602 A1 by-way of example are contraceptives. In a variant to this principle, DE 41 34 237 C1 and EP 0 191 168 A2 specify the insertion of a blister pack into an apparatus in which an electrical contact is closed when a tablet is pressed out of the blister pack. In the case of EP 0 191 168 A2, the blister pack is accommodated in a holding frame which at least partially surrounds said blister pack and allows coated tablets to be pressed out of the blister pack on account of its at least partially open design at least at the bottom.

Furthermore, DE 198 36 100 A1 describes an apparatus for storing a blister pack which has an accommodating part for the blister pack. The accommodating part has openings for pressing medicaments out of the accommodated blister pack and a signal-transmitter part for setting time intervals and for outputting signals in accordance with the entered time intervals. Each opening in the accommodating part has an associated optical indicator device for outputting an optical signal in accordance with the entered time intervals. When the medicament is due to be administered, that optical indicator device which is associated with the corresponding tablet in the blister pack begins to flash. Administration of the tablet is confirmed by pressing a key, so that an acoustic alarm, which drew attention to the fact that the administration was due, is switched off.

Furthermore, DE 102 17 929 A1 describes an apparatus for dispensing tablets, having means for accommodating a blister pack, means for pressing a tablet out of the blister pack, and means for setting administration times and means for indicating administration times. The apparatus has a lower part and a cover which is detachably connected to the lower part for accommodating the blister pack, with the arrangement of the means being matched to the arrangement of the tablets in the blister pack to be accommodated. If a tablet is removed, electrical contact is made between a pushbutton and a printed circuit board which is arranged in the cover, so that removal of the tablet is registered. The means for indicating the administration times is a flashing alarm symbol on an LCD display or an acoustic signal. Instead of automatic registration of the removal of a tablet, said removal can also be confirmed manually, whereupon the alarm is cancelled.

A further embodiment is described in US 2004/0050746 A1. In this case, a blister pack is inserted into a holder, so that an electrical circuit and therefore a timer are activated. This activation triggers an alarm after a predefined period of time, which alarm indicates that the medicament is due to be administered.

In other embodiments of corresponding holders for blister packs, removal of a medicament is registered manually:

To this end, WO 01/54646 A2 describes a pill dispenser with an alarm function, said pill dispenser comprising a blister pack and a microprocessor for storing an administration time interval and for activating a visual or acoustic alarm. When a tablet is removed from a corresponding receptacle of the blister pack, a button is pressed in one embodiment, and this confirms removal. This starts up a clock. After a predetermined time interval has elapsed, the alarm is activated, whereupon a further tablet should be taken. The medicaments mentioned are, for example, medicaments for hormonal treatment.

DE 20 2004 012 232 U1 specifies a pill clock for contraceptives, in which a digital clock is combined with a pill box. The digital clock can be worn on the wrist like a wristwatch. Alarm modes which may be acoustic are provided in order to indicate that the medicaments are due to be administered. In addition to an acoustic alarm, administration times for the medicaments are digitally displayed on a display. It is possible to confirm that a medicament has been administered by pressing corresponding buttons. In addition to alarm symbols, the clock may also numerically display the time period until the next administration is due.

A clock without storage options for such medicaments is described in DE 298 11 525 U1. The functionalities of this clock are comparable with those of the pill clock from DE 20 2004 012 232 U1.

The arrangement for monitoring administration of pills, in particular contraceptives, which is shown in DE 197 13 915 A1, has suitable optical indicator elements and acoustic signal transmitters which communicate the parameter values for the functions of the last administration time, the next administration time, the time which has elapsed since the removal time, and the time of day. An administration key is to be operated when the medicaments are administered. In order to aid administration of the medicaments, the clock housing also has a drawer for accommodating a blister pack containing at least 21, preferably 28 or more, pills.

Furthermore, DE 202 07 266 U1 discloses a pill case for contraceptives with a clock and an alarm function. In this case, the clock can be positioned separately from a case which accommodates the blister pack.

For effective contraception, it is necessary to take the medicament portions regularly. It is particularly important to administer low-dose hormonal preparations as accurately as possible in terms of time. In this case, it is necessary to take the medicament within a relatively narrow time window in order to ensure sufficient contraceptive protection. The medicament portions are taken regularly over a specific period of time, for example for 21 days, with one portion usually being taken every day (administration phase). This time period is followed by the administration-free time period, for example a time period lasting 7 days. After this time period, a time period involving regular administration is again started. Renewed administration of the medicament portions has to be started promptly after the end of the administration-free phase otherwise sufficient protection against pregnancy is not provided.

The present invention is therefore based on the problem that the known apparatuses are not reliable in terms of determining the time at which administration of contraceptives has to be started again following a break. This problem is particularly apparent in the present case because the apparatus to be provided needs to be suitable for a variable administration regime in which a renewed administration time following an administration break does not necessarily recur regularly.

This problem is solved by means of the dispenser for solid medicament portions according to claim 1 and by means of the use of the dispenser according to claim 26. Preferred embodiments of the invention are specified in the subclaims.

The inventive dispenser for solid medicament portions preferably serves for accommodating medicament packs which, in particular, contain hormonal medicaments for contraception or hormone replacement therapy. In cases such as this, it is vital to follow the prescribed medicament-administration regime as accurately as possible in order to ensure complete protection against pregnancy or to ensure therapeutic success. An administration regime such as this is characterized by regularly recurring administration times. However, the administration phases and administration-break phases may be of different lengths. Particularly in the case of low-dose contraceptives, it is necessary to take the individual medicament portions during an administration phase at predetermined times at time intervals which are as uniform as possible. It is very particularly important to comply with these instructions when, as in the case of novel preparations, it is possible to uniformly administer the medicament in a 24-hour cycle during the administration phase for at least 24 days and generally no more than 120 days. In this case, said administration phase is followed, for example, by an administration-free phase of four days. These time periods have to be complied with as accurately as possible. In accordance with this novel administration regime, it is also possible to variably include an administration phase which is a maximum of four days long; after an administration break, uniform daily administration then has to be continued until the next variable break.

In order to ensure that the instructions are also followed when the contraceptives would not normally be taken regularly due to other distractions of everyday life and moreover when there is no systematic self-monitoring over the length of the administration-free phase, the invention proposes providing a dispenser for solid medicament portions, in particular medicament portions contained in a blister pack, which dispenser has
a. a case for the medicament portions and
b. means for providing a reminder to administer the medicament portions.

The means for providing a reminder to administer the medicament portions comprise the following components:
i. at least one processor unit,
ii. at least one signalling device which is associated with the at least one processor unit, and
iii. at least one means, which is associated with the at least one processor unit, for confirming that the next medicament portion has been administered.

The processor unit may, in particular, be a conventional microprocessor which is programmed in a suitable manner, so that it possesses the required functions, for example the function of a timer, an arithmetic unit and the necessary control devices for the external devices, such as the signalling devices, the means for confirming that a medicament portion has been administered, and the means for initializing a break period in administration of the medicament portions after an administration-free phase. The signalling device outputs the respectively current state of medicament administration.

As soon as a medicament portion has been taken, this has to be confirmed. To this end, the dispenser has the at least one means for confirming that a medicament portion has been administered. This confirmation may, for example, result in a counter in the arithmetic unit being increased by one since the number of portions which have already been taken is increased by one unit. Furthermore, the calculated time period since the beginning of the first administration is extended in the arithmetic unit by a further increment of one time period between two due times, generally 24 hours, until the last due time is reached.

In an inventive manner, the dispenser additionally comprises
iv. at least one means, which is associated with the at least one processor unit, for initializing a break period in administration of the medicament portions.

These additional means for initializing the break period in administration is preferably selected from a group comprising manual operating means and speech-recognition means. Therefore, it is possible to start the ‘break in administration of the medicament’ mode by operating a manual operating means, for example a momentary-contact switch, or by speech. The momentary-contact switch may be, for example, a tactile momentary-contact switch, that is to say a manual operating means which initially provides a slight resistance when it is pressed and then suddenly yields when it is pressed further, so that operation can be easily perceived by touch.

The at least one means for initializing a break period in administration of the medicament portions serves to take into account the administration-free time period between two administration phases, so that the signalling devices indicate the next due time which occurs after the break period in administration elapses. A new administration phase is launched only after the break period in administration has elapsed. Since this is automatically output by the signalling devices, it is never necessary to provide any means other than the inventive dispenser to determine the times at which administration is due. This ensures maximum reliability for administration of the medicaments, even after a break in administration. In addition, there is no need to make separate notes about renewed administration after the break period in administration elapses or to remember the new administration time.

The at least one processor unit and the at least one signalling device are preferably formed such that a time at which a medicament portion is due to be administered for the first time in a new administration phase following initialization of the break period in administration is calculated by the at least one processor unit and indicated by the at least one signalling device. Renewed administration of a medicament portion is due immediately when this time period elapses. Automatically indicating that administration is due prevents this time period and therefore the due time elapsing and renewed administration of a medicament being missed.

The at least one processor unit and the at least one signalling device are preferably formed such that a reminder to administer a medicament portion is provided at the precise time. This applies both for times at which medicament portions are to be administered during the administration phase and also for the first administration following a break in administration and therefore at the beginning of a new administration phase. Therefore, the time at which administration of the medicament portions is due does not depend on the last time at which a medicament portion was actually administered, but rather on the theoretically correct time which is calculated from the first administration time of a first administration phase and the subsequent time periods between the individual due times and possibly break periods.

According to the preferred embodiment specified above, a current break period depends on the last calculated time at which a medicament portion was due to be administered or on the time of the first administration of a first administration phase. Therefore, even if the last medicament portion was not taken precisely at the last due time and/or the break period had not been initialized precisely at the following due time, introduction of the break period ensures the next due time occurs at the precise time.

The above measures mean that the due times are always calculated very precisely, irrespective of the inaccuracy of the times at which the medicament portions are actually taken. This is extremely important for effective contraception or therapy.

In a further embodiment of the invention, the at least one signalling device is formed such that it outputs the time remaining until the next administration is due. It is thus possible to identify at each time the later time at which renewed administration will be necessary. This also provides the further information as to whether the last medicament portion was taken or not.

Furthermore, in a further preferred embodiment of the invention, the at least one signalling device is formed such that it outputs the number of medicament portions which have already been taken in a current administration phase. It is thus always possible to identify how many medicament portions have already been taken in the current administration phase. This is important not only for conventional preparations in the field of contraceptives, but particularly also for modern preparations, since these allow the length of the administration phase to be varied. For example, the length of the administration phase may last at least 24 days and generally at most 120 days.

In order to be able to set the abovementioned output modes on a signalling device, the dispenser may have, in a further preferred embodiment, at least one changeover means which is used to select whether either the time remaining until the next due time, or the number of medicament portions which have already been taken is output by the signalling device. In addition, the changeover means can also be used to select a mode in which the due time, that is to say the corresponding time of day and optionally also a date and/or day of the week, are output. Provision may also be made for initially the number of days in a break period and then the number of hours remaining until the first due time in the next administration phase is reached to be indicated successively by actuating the changeover means, for example pressing a momentary-contact switch, a number of times.

Like the means for initializing the break period in administration, this changeover means may also be a tactile momentary-contact switch (information button). The changeover means may have the additional function of reactivating a dispenser which has passed into a battery-saving state after not having been used for a relatively long time. A saving state such as this may arise when the dispenser is not operated for a relatively long time period, for example over 15 minutes, in order to prevent excessive use of the battery, for example by the signalling device.

If the next intended medicament portion is not taken within a predefined time window, for example within 12 hours, after a due time, provision may be made, in a further preferred embodiment of the invention, for the at least one signalling device to be formed such that it outputs a signal that this time window has been exceeded.

Furthermore, the signalling device can also indicate whether an administration phase is currently in progress or a break has been initialized.

Finally, the signalling device can also indicate the charge state of a battery which is provided in the dispenser, in order to ensure that said battery is sufficiently able to supply the dispenser with electrical power at any time.

The at least one signalling device is preferably selected from a group comprising optical, acoustic and haptic indicator means. Optical indicator means may be, for example, illuminated or unilluminated liquid crystal displays. Possible acoustic indicator means include buzzers or bells and sound generators, including programmed reproduction devices for melodies. Haptic indicator means include, for example, vibrating means which can discreetly draw attention to a due time.

The means for confirming that a medicament portion has been administered can be selected from a group comprising manual operating means and speech-recognition means. Therefore, administration of a medicament portion can be confirmed, for example, by a pushbutton or by means of speech input. Like the means for initializing the break period in administration, the confirmation means may preferably be a tactile momentary-contact switch.

In order to ensure that the input has actually been carried out just once for confirmation that a medicament portion has been administered, the dispenser according to the invention may also have at least one corresponding indicator device. This indicator device may be an LED, for example.

The case of the dispenser may preferably comprise a first case half for accommodating a receptacle for a medicament pack (blister pack) containing solid medicament portions and a second case half which is hinged-connected to the first case half. The case halves may, for example, be produced from plastic, for example from an acrylonitrile/butadiene/styrene copolymer, polycarbonate or a mixture of these plastics with one another or with other plastics.

The first case half may, in particular, have an insert compartment for the medicament pack. As a result, the blister pack can be conveniently accommodated in the dispenser. To this end, the insert compartment can have guide rails on two mutually opposite sides and a stop on a third side. As a result, the medicament pack can be inserted into the insert compartment via a fourth side. The guide rails may, in particular, be provided in the case half in the longitudinal direction, so that the pack can be inserted into the case half via the narrow side.

Since the fourth side of the first case half is open approximately level with the insertion plane in order to be able to insert the blister pack, the second case half has an apron on a side which corresponds to the fourth side of the insert compartment. This prevents an inserted medicament pack falling out when the case is closed.

The second case half preferably comprises the at least one signalling device, the at least one means for confirming that a medicament portion has been administered, and the at least one means for initializing the break period in administration. The at least one signalling device is preferably arranged on an outer face of the second case half. As a result, it is possible to easily identify the administration status without having to open the case. The changeover means may also be provided on the second case half.

The at least one means for confirming administration and the at least one means for initializing a break period in administration are preferably arranged on an inner face of the second case half. As a result, unintentional operation of these means is largely precluded. This makes a significant contribution to the reliability of administration. Like the signalling device, the changeover means can also be arranged on the outer face of the second case half. In order to prevent the changeover means from being unintentionally operated, said changeover means may preferably be formed as a momentary-contact switch which is embedded in a recess in the surface of the case half. The same applies to the means for confirming administration and the means for initializing the break period in administration.

The following figures serve to further illustrate the invention. In detail,

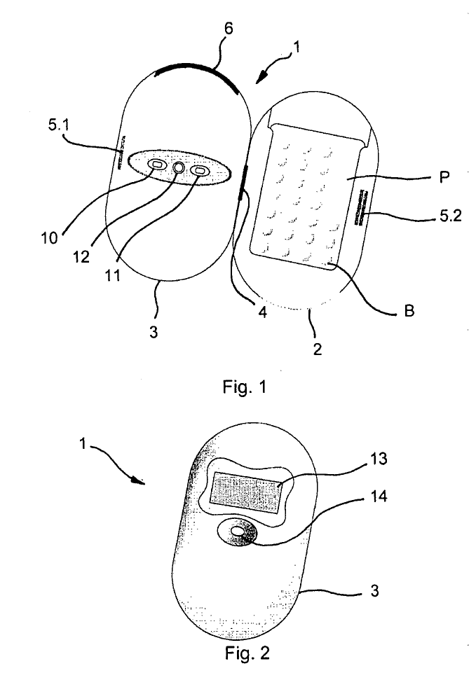

FIG. 1: shows a perspective view of a dispenser in the open state;

FIG. 2: shows a perspective view of a dispenser in the closed state; and

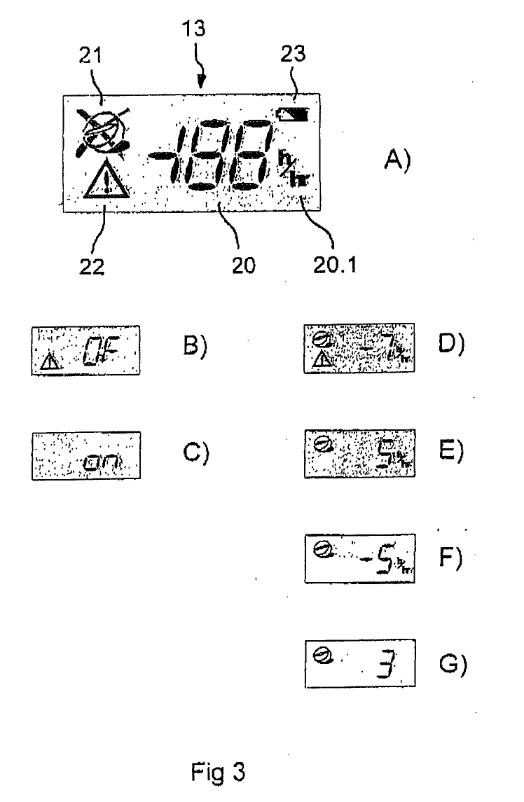

FIG. 3: shows an illustration of the indicator of the signalling device with various indicator states.

Identical reference symbols in the figures refer to the same elements.

FIG. 1 shows a perspective view of a dispenser 1 in the open state. The case 1 comprises a first case half 2 and a second case half 3. The two halves are hinge-connected to one another by a hinge 4. The first case half accommodates a blister pack P with receptacles B for medicament portions. The blister pack is inserted into a guide in the first case half from the remote side and firmly held there. The second case half can be closed over the first case half, with a locking mechanism 5.1, 5.2 ensuring that the case is not opened during transportation. In the closed state, an apron 6 on the second case half further ensures that the blister pack does not slide out of the guide and out of the dispenser.

A tactile momentary-contact switch 10 for initializing a break period in administration of the medicament portions (terminate button) is arranged on the inner face of the second case half 3. Furthermore, a tactile momentary-contact switch 11 for confirming that a medicament portion has been administered (confirmation button) is provided on this face of the second case half. An LED 12 is also arranged between the terminate button and the confirmation button, this LED serving to indicate confirmation that a medicament portion has been administered by means of the confirmation button.

FIG. 2 shows a perspective view of a dispenser in the closed state. The case 1 which comprises a first case half (not illustrated) and a second case half 3 has, on the outer face, a liquid crystal display 13 as the signalling device and an information button 14 for changing over between outputting the time remaining until a next administration is due and outputting the number of medicament portions which have already been taken. The information button is in the form of a tactile momentary-contact switch.

A microprocessor, which is accommodated in the dispenser and which is programmed such that it has the required functions, is not illustrated. In addition, a battery is also provided which serves to supply power to the microprocessor, to the liquid crystal display and to the LED.

FIG. 3A shows an illustration of the liquid crystal display with all of the available indicator elements. The liquid crystal display firstly has an alphanumeric field 20 for indicating the time remaining until a next administration of medicament is due or for indicating the number of medicament portions which have already been taken. In the present case, a replacement character 20 is specified for illustrating the remaining time (indicated by the unit display 20.1 in ‘h/hr’ for ‘hours’), it being possible to see that the display in the alphanumeric field may be negative if the due time has already passed without a due medicament portion having been taken and therefore the confirmation button not yet having been operated either.

A tablet symbol is included in an upper left-hand symbol field 21, this tablet symbol being crossed through in the present case. If the symbol is not crossed through, it signals that an administration phase is currently in progress. If, as in the present case, the symbol is crossed through, it indicates a break phase.

A warning sign may be provided in the lower left-hand symbol field 22, this warning sign indicating that the next intended medicament portion has not been taken within a predefined time window after the last due time, so that adequate protection or the desired therapeutic action is no longer ensured. If an administration phase is not in progress, so that a crossed-through tablet symbol is displayed in the upper left-hand symbol field 21, no warning sign is displayed in the lower left-hand symbol field 22 since it is not necessary to take a medicament portion.

The upper right-hand symbol field 23 shows whether the battery which is contained in the dispenser and serves to supply power is still sufficiently charged or not. In the present case, the symbol indicates that the service life of the battery will soon end.

In order to start the indicator, the information button 14 is operated. As a result, the liquid crystal display 13 is put into operation. The confirmation button 11 is operated when a first medicament portion is administered. This triggers a timer in the microprocessor and starts the internal clock. When the microprocessor is programmed with a 24-hour administration interval in a fixed manner, an alarm is triggered after exactly 24 hours. This alarm firstly involves displaying the time remaining until the next due time (in this case ‘0 h/hr’) and an acoustic warning sign, for example a buzzer tone which is produced at intervals. If the medicament portion is taken shortly after this, the liquid crystal display 13 displays ‘24 h/hr’ or (after changeover) ‘1’ (“one medicament portion has been taken”).

After 24 medicament portions are taken, the break period in administration is initialized for example. In this case, the liquid crystal display 13 is set to “4 d” (4 days). In addition, the corresponding crossed-through tablet symbol 21 appears in place of the first tablet symbol which was not crossed through. After four days have expired, the indication ‘0 h/hr’ (rest period of 0 h) or ‘0’ (no medicament portion taken yet) appears on the liquid crystal display again. In addition, the alarm buzzer sounds.

FIGS. 3B and 3C illustrate indicator options which signal an acoustic warning signal being switched on or switched off when a due time is reached. These indicators are illustrated in the alphanumeric field 20 in FIG. 3A. When the acoustic warning signal is switched off, a warning sign is simultaneously provided in the lower left-hand symbol field 22.

FIG. 3D shows an indicator situation which appears when a time window, for example of 6 hours after the last time the administration was due, is exceeded without a medicament portion having been taken: in this case, the alphanumeric symbol field 20 indicates that the last due time was 7 hours ago. Displaying the warning sign in the lower left-hand symbol field 22 additionally indicates that the said time window has been exceeded. In addition, the tablet symbol in the upper left-hand symbol field 21 indicates that an administration phase is currently in progress.

FIG. 3E shows an indicator situation which appears before a due time is reached: the upper left-hand symbol field 21 indicates that an administration phase is in progress. The alphanumeric symbol field 20 shows that the next due time will be reached in five hours.

FIG. 3F shows an indicator situation which appears after the last due time has passed without a medicament portion having been taken: in this case, the alphanumeric symbol field 20 indicates that the due time was already reached five hours ago. However, the time window is not yet exceeded since no warning sign appears in the lower left-hand symbol field 22.

FIG. 3G shows an indicator situation which appears before that due time at which the fourth medicament portion in the current administration phase has to be taken is reached. Therefore, a ‘3’ appears in the alphanumeric symbol field 20 for the medicament portions previously taken.

### LIST OF REFERENCE SYMBOLS

| | |
|---|---|
| 1 | Dispenser |
| 2 | First case half |
| 3 | Second case half |
| 4 | Hinge |
| 5.1, 5.2 | Locking mechanism |
| 6 | Apron |
| 10 | Terminate button |
| 11 | Confirmation button |
| 12 | LED for indicating confirmation of administration |
| 13 | Liquid crystal display |
| 14 | Information button |
| 20 | Alphanumeric symbol field |
| 20.1 | Unit display |
| 21 | Symbol field for the administration phase |
| 22 | Symbol field for a warning sign |
| 23 | Symbol field for the charge state of a battery |
| P | Medicament pack |
| B | Receptacle for medicament portions |

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding German application No. 10 2005 048515.4, filed Oct. 5, 2005, is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Dispenser for solid medicament portions, comprising:
a. a case (1) for the medicament portions and
b. means for providing a reminder to administer the medicament portions, comprising
i. at least one processor unit,
ii. at least one signalling device (13) which is associated with the at least one processor unit, and
iii. at least one means (11), which is associated with the at least one processor unit, for confirming that a medicament portion has been administered, characterized in that
iv. at least one means (10), which is associated with the at least one processor unit, for initializing a break period in administration of the medicament portions after an administration phase is additionally included.

2. Dispenser according to claim 1, characterized in that the at least one processor unit and the at least one signalling device (13) are formed such that a time at which a medicament portion is due to be administered for the first time following initialization of a break period in administration is calculated by the at least one processor unit and output by the at least one signalling device (13).

3. Dispenser according to claim 1, characterized in that the at least one means for initializing the break period in administration (10) is selected from a group comprising manual operating means and speech-recognition means.

4. Dispenser according to claim 1, characterized in that the at least one means for initializing the break period in administration (10) is a tactile momentary-contact switch.

5. Dispenser according to claim 1, characterized in that the at least one processor unit and the at least one signalling device (13) are formed such that a reminder to administer a medicament portion is provided at the precise time.

6. Dispenser according to claim 1, characterized in that the at least one signalling device (13) is formed such that it outputs the time remaining until the next administration is due.

7. Dispenser according to claim 1, characterized in that the at least one signalling device (13) is formed such that it outputs the number of medicament portions which have already been taken in one administration phase.

8. Dispenser according to claim 6, characterized in that at least one changeover means (14) is provided which is used to select whether either the time remaining until the next administration is due, or the number of medicament portions which have already been taken in the administration phase is output by the signalling device (13).

9. Dispenser according to claim 8, characterized in that the at least one changeover means (14) is a tactile momentary-contact switch.

10. Dispenser according to claim 1, characterized in that the at least one signalling device (13) is formed such that it outputs a signal that a predefined time window after a time at which the next administration was due has been exceeded.

11. Dispenser according to claim 1, characterized in that the at least one signalling device (13) is selected from a group comprising optical, acoustic and haptic indicator means.

12. Dispenser according to claim 1, characterized in that the at least one signalling device (13) is a liquid crystal display.

13. Dispenser according to claim 1, characterized in that the at least one means (11) for confirming that a medicament portion has been administered is selected from a group comprising manual operating means and speech-recognition means.

14. Dispenser according to claim 1, characterized in that the at least one means (11) for confirming that a medicament portion has been administered is a tactile momentary-contact switch.

15. Dispenser according to claim 1, characterized in that the at least one device (12) for indicating confirmation that a medicament portion has been administered is provided.

16. Dispenser according to claim 15, characterized in that the at least one device (12) for indicating confirmation that a medicament portion has been administered is an LED.

17. Dispenser according to claim 1, characterized in that the case (1) comprises a first case half (2) for accommodating a receptacle (B) for a medicament pack (P) containing solid medicament portions and a second case half (3) which is hinged-connected to the first case half (2).

18. Dispenser according to claim 17, characterized in that the first case half (2) has an insert compartment for the medicament pack (P).

19. Dispenser according to claim 18, characterized in that the insert compartment has guide rails on two mutually opposite sides and a stop on a third side, so that the medicament pack (P) can be inserted into the insert compartment via a fourth side.

20. Dispenser according to claim 19, characterized in that the second case half (3) has an apron (6) on a side which corresponds to the fourth side of the insert compartment of the first case half (2), in order to prevent an inserted medicament pack (P) from falling out when the case (1) is closed.

21. Dispenser according to claim 18, characterized in that, beneath the insert compartment for the medicament pack (P), the second case half (2) has a drawer for receiving medicament portions which have been pushed through.

22. Dispenser according to claim 17, characterized in that the second case half (3) comprises the at least one signalling device (13), the at least one means (11) for confirming that a medicament portion has been administered, and the at least one means (10) for initializing the break period in administration.

23. Dispenser according to claim 22, characterized in that the at least one signalling device (13) is arranged on an outer face of the second case half (3).

24. Dispenser according to claim 22, characterized in that the at least one means (11) for confirming administration and the at least one means (10) for initializing the break period in administration are arranged on an inner face of the second case half (3).

25. Dispenser according to claim 1, characterized in that it contains an inserted blister pack.

26. Use of the dispenser according to claim 1 for hormonal medicaments for contraception or hormone replacement therapy.
